(19) United States
(12) Patent Application Publication
(10) Pub. No.: US 2012/0205928 A1
(43) Pub. Date: Aug. 16, 2012

(54) Gripper Assembly for Mechanical Device

(76) Inventors: Stefano La Rovere, Auderghem (BE); Jia-wei Chiu, Hoepfingen (DE); Andreas Boettcher, Wallduern (DE); Jeffrey Kyle Werner, Liberty Township, OH (US)

(21) Appl. No.: 13/025,185

(22) Filed: Feb. 11, 2011

(51) Int. Cl. B25J 15/06; B25J 15/00

(52) U.S. Cl. 294/183; 294/86.4; 901/40

(57) ABSTRACT

A gripper assembly for a mechanical device includes an elongate arm in engagement with robotic translation and rotation means. The elongate arm has a platform with at least one elongate member having a bearing bore defined at a free extent thereof. Each bearing bore accommodates insertion of a bearing shaft upon which a gripping mechanism, such as a suction cup assembly, is rotatably supported. The suction cup assembly includes a pivoting arm having a pivoting bore in engagement with a free extent of a linkage element that establishes pivotable movement between the pivoting arm and an actuator means. The gripper assembly has a center of mass substantially aligned with a vertical rotation axis between an initial article picking orientation, wherein the suction cup assembly engages an article in a random orientation, and a successive article rotation orientation, wherein the suction cup assembly rotates a picked article around a horizontal axis for placement in an article placement position.

### FIELD OF THE INVENTION

The invention is directed to a gripper assembly for a mechanical device. In some embodiments, the gripper assembly may be used for robotic or mechanical picking and placing articles, containers, devices and other objects from a conveyance device for subsequent treatment thereof at one or more treatment stations along a production line.

### BACKGROUND OF THE INVENTION

A variety of robot configurations currently undertake various tasks in manufacturing sites. Among these tasks are the picking and placing of objects that are delivered from an initial receptacle (such as a hopper) to a conveyance device (such as a conveyor belt) upon which the articles are initially in various random orientations (“initial article picking position”). Known devices for picking and placing articles (hereinafter “pickers”) are entrusted with the task of picking up such articles and re-orienting them into a position (“article placement position”) where each article is properly positioned for at least one subsequent treatment at one or more treatment stations located within an assembly facility.

Pickers that arrange articles from an initial position to any successive position typically include a robotic arm of which a moveable end-effector thereof is connected to a gripper. A programmable controller moves the robotic arm and gripper to the article, picks up the article by controlling the gripper, moves the robotic arm to at least one successive position and releases the article by controlling the gripper (for instance, to place the article into a conveyable position for conveyance on a running belt, a vacuum-conveyer, a neck-conveyer or by other conveyance means ; or to alternatively place the article into a receptacle with like articles to effect grouping of like articles prior to further processing, for instance, to place like articles on a pallet for placement of identifying article bar codes on the articles and/or the pallet). In typical configurations, the gripper includes a pick-up mechanism for picking and placing an article. The mechanism may be one of many kinds of tools known to those skilled in the art such as, for example, a magnetic device, a vacuum or suction device, a mechanical device or any other known device, depending on the characteristics of the article to be picked and placed. Once the gripper has picked up the targeted articles, the gripper moves the items into a successive position relative to the rest of the packaging system for eventual release.

In consideration of the need for pickers to work within a real three-dimensional environment, enhancement to gripping technique can similarly enhance the pickers' ability to accomplish tasks efficiently. Changes to configurations need to account for safe manipulation of an article in the manipulation space (that is, the area necessary to manipulate the object) and the manipulation cost that is the necessary time to finish the manipulation. It is therefore necessary to bring an article from a relatively unknown position and orientation to a known orientation (but possibly unknown position) with minimal means. Assuming an article of an undetermined geometry assumes an initial position in a random configuration and the only force acting on it is gravity, considering the geometry and mass of the container, a robotic arm with a camera could detect the current article picking orientation, pick up the article and then put it in the “proper” article placement position. This approach can be costly if a high throughput is necessary, and, with current gripper configurations, it may be necessary to re-grip an article in order to successfully get it between the article picking and article placement positions.

Original commercial gripper designs addressed this by providing a double-rotation configuration to overcome inherent risks in relation to inertia and article height that were experienced in traditional 90° turning tools. During the picking operation, the grippers pick an article, flip the article vertically through rotation around a horizontal axis, orient the article to a proper processing orientation around a vertical axis, convey the article to a final destination, place the article at the final destination (for instance, upon a conveyor) and release the article in a stable position. Referring to FIG. 1, a standard double-rotation gripper assembly 10 is provided with a pivotable arm 12 having a suction assembly 14 at a free extent thereof for gripping an article (not shown). The article may be picked from a plurality of articles arranged in random orientations along a moving conveyance apparatus such as a conveyor belt (not shown).

The center of mass of gripper assembly 10 is maintained along a vertical axis 16 that is displaced from a vertical axis 18 along which the gripper's center of rotation is disposed. The displacement of the gripper assembly's center of mass relative to its center of rotation contributes heavily to vibratory disturbance due to inertial effects, and thereby decreases the mean time between failures (MTBF) of the overall system. In addition, pivotable arm 12 requires an extended time to stabilize the article vibrations during the robot trajectory, thereby escalating the time increments a packaging system requires to effect proper orientation of articles from an original random orientation. The industry standard gripper configuration further includes many interacting parts that require significant investments of time and money for installation, operation and maintenance. In order to improve the speed of reorientation tasks, cooperation by multiple robot pickers is often employed, in which case these factors negatively affect the ability to execute predictable picking operations for multiple installations. Where packaging of articles is facilitated on a round-the-clock basis, all of the aforementioned factors contribute to excess MTBF and further reduce the productivity and reliability of entire packaging systems.

Another way to increase the overall speed of a system is to implement a multiple gripper (such as multiple suction cups) on the end-effector of a robot. Such multiple grippers can grasp several articles simultaneously from the article picking position to pick-up and place two or more articles at the same time. This solution, however, not only increases the weight of the gripper, but also increases the complexity (and therefore the associated cost, operability and maintainability) of the device, and especially constrains use of the gripper to only a few specific article shapes. The increase in changeover time between different articles effectively diminishes the flexibility of the overall system and defeats any benefit attributable to production speed realized by the multiple gripper configuration.

To achieve desired flexibility benefits with minimum changeover time, a pick-and-place gripper assembly that can be adjustable for picking and placing a variety of articles advantageously addresses the other gripper systems' failure to dispose a gripper's center of gravity near its axis of rotation. Such a gripper assembly can be adjusted in an efficient manner and has enough versatility to be utilized in a number of different environments. A pick-and-place gripper assembly demonstrates such advantages, by placing the center of gravity more close to the axis of rotation, thereby accomplishing the foregoing features and yet remaining economical to manufacture, install and use for long-term packaging operations requiring round-the-clock predictability and reliability, even in case of frequent article changes.

### SUMMARY OF THE INVENTION

According to an aspect of the invention, a gripper assembly for a mechanical device is provided for picking an article from a random orientation. The gripper assembly includes an elongate arm having a platform with an upper surface and an opposed lower surface defining a predetermined thickness therebetween. At least one elongate member depends normally from the platform's lower surface such that each elongate member has a body of predetermined length, with each member body having an inner surface separable from any adjacent inner surface by a predetermined distance. Each body includes a platform extent adjacent the platform's lower surface and an opposed cantilever extent having a cylindrical bearing bore defined therethrough. In configurations in which the arm has more than one elongate member, the bearing bores are positioned coaxially relative to one another to accommodate insertion of a bearing shaft with a gripping mechanism rotatably supported thereby. The gripping mechanism includes a holder having a cylindrical bore to accommodate insertion of the bearing shaft therethrough. A pivoting arm depends outwardly from a bottom surface of the holder and terminates in a pivoting extent having a pivoting bore defined thereat. An actuator means (such as a pneumatic cylinder or an electrical or mechanical actuator) is in operable communication with the pivoting arm such that, upon actuation thereof, the actuator means imparts pivotable movement to the pivoting arm and resultant rotational motion to the gripping mechanism about a horizontal axis. The actuator means is disposed relative to the inner surfaces of adjacent member bodies so as to be pivotably movable relative to the elongate arm. A linkage member has a coupled extent in operable communication with the actuator means and a free extent with a fork head defined thereat, wherein the fork head includes a pair of tines. Each tine has a fastening bore defined therethrough such that the fastening bores are in coaxial alignment with one another and in further registry with the pivoting bore when the pivoting arm is disposed between the tines. In this configuration, the gripper assembly has a center of mass substantially aligned with an axis of rotation of the gripper assembly throughout actuation of the actuator means.

According to an aspect of the invention, a gripper assembly for a mechanical device picks an article from a plurality of articles randomly distributed along a conveyance apparatus. The gripper assembly includes an elongate arm in engagement with robotic means that effects translation of the gripper assembly on a horizontal plane and on a vertical axis, and rotation of the gripper assembly around a vertical rotation axis. The elongate arm has a platform with at least one elongate member depending normally from a lower surface thereof. Each elongate member has a body of predetermined length with each member body having an inner surface separable from any adjacent inner surface by a predetermined distance. Each member body further includes a platform extent adjacent the platform's lower surface and an opposed cantilever extent having a cylindrical bearing bore defined therethrough. In configurations where the arm has more than one elongate member, the bearing bores are positioned coaxially relative to one another to accommodate insertion of a bearing shaft that rotatably supports a gripping mechanism thereby. The gripping mechanism includes a holder having a cylindrical bore to accommodate insertion of the bearing shaft therethrough. The holder includes a pivoting arm depending outwardly from a bottom surface thereof and terminating in a pivoting extent having a pivoting bore defined thereat. An actuator means (such as pneumatic cylinder or an electrical or mechanical actuator) is provided with a linkage member having a coupling extent in operable communication therewith and a free extent with a fork head defined thereat. The fork head includes a pair of tines wherein each tine has a fastening bore defined therethrough. The fastening bores are in coaxial alignment with one another and in registry with the pivoting bore when the pivoting arm is disposed between the tines, thereby establishing operable communication between the linkage member and the pivoting arm. The actuator means is disposed relative to the inner surfaces of adjacent member bodies so as to be pivotably movable relative to the elongate arm, whereupon actuation of the actuator means, the pivoting arm imparts rotational motion to the gripping mechanism about a horizontal axis. In this configuration, the gripper assembly has a center of mass substantially aligned with the vertical rotation axis between an initial article picking orientation, in which the gripping mechanism engages an article in a random orientation, and a successive article rotation orientation, in which the gripping mechanism rotates a picked article around a horizontal axis for placement in an article placement position.

The gripping mechanism may comprise any known end effector, including a suction cup assembly having a support surface for retention of a suction head in a generally planar orientation. The pivoting arm and holder of the gripping assembly may be integral with one another or detachably coupled, so long as pivoting of the pivoting arm upon actuation of the actuation means effects rotational movement of the gripping assembly and resultant orientation of the gripping mechanism between the initial article picking position and the successive article rotation position.

The disclosed gripper assembly can selectively include a cylindrical shaft bore defined along a length of each member body. Such shaft bores are positioned coaxially relative to one another to accommodate insertion of an alignment shaft therethrough.

The gripper assembly is configured such that the assembly's center of gravity of the assembly remains substantially aligned with the axis of rotation of the robot to which the assembly is rotatably mounted. The rotational inertia realized by the gripper assembly during rotation thereof is minimized due to a significant reduction in acceleration and vibrations. As a consequence, the gripper assembly demonstrates a very precise pick-and-place at an accelerated rate.

### BRIEF DESCRIPTION OF THE DRAWINGS

FIG. 1 is a perspective view of an industry standard gripper assembly.

FIG. 2 is a perspective view of a gripper assembly mounted on a robotic platform.

FIG. 3 is a perspective view of the gripper assembly of FIG. 2 apart from a robotic platform.

FIG. 4 is an exploded view of the gripper assembly of FIG. 3.

FIGS. 5 and 5A are side and front views, respectively, of the gripper assembly in an initial article picking position.

FIGS. 6 and 6A are front and side views, respectively, of the gripper assembly in a subsequent article rotation position.

### DETAILED DESCRIPTION OF THE INVENTION

The invention is directed to a gripper assembly for a moving device, such as a mechanical device. The moving device may be any suitable device that is capable of moving articles. Mechanical devices include, but are not limited to pneumatic arms, robots, and other mechanical moving elements. The mechanical device may be actuated in any suitable manner including, but not limited to mechanically, electrically, and combinations thereof, and is not limited to devices that are mechanically actuated. Although the present application describes the mechanical device in the context of a robot, the present invention is not limited to use with a robot, and it should be understood that the term “robot” may be replaced in all instances with the terms “moving device” or “mechanical device”.

In certain embodiments, the gripper assembly is used for picking and placing articles, containers (which may be empty, or at least partially filled), devices and other objects (referred to herein as an “article” or collectively as “articles”) from a conveyance device for subsequent treatment thereof at one or more treatment stations along a production line. Such treatment stations include but are not limited to stations for labeling, filling, capping and sealing the articles, which stations can electively treat the properly positioned articles in succession for eventual delivery from the manufacturing site. The gripper assembly is not limited to such a use, and can be used for any other purposes for which robotic gripper assemblies are generally used.

In certain embodiments, the invention is directed to a gripper assembly that maintains the gripper assembly's center of mass substantially aligned with a vertical rotation axis while the assembly moves a picked article between an initial article picking position, in which the gripper assembly engages an article in a random orientation, and a successive article placement position, in which the gripper assembly rotates a picked article around a horizontal axis for eventual placement in a stable conveyable position for subsequent treatment. The term “substantially aligned”, as used herein, refers to relationships in which the distance between the gripper assembly's center of mass and vertical rotation axis is less than or equal to about 25 mm Thus, the term “substantially aligned” includes relationships in which the distance between the gripper assembly's center of mass and vertical rotation axis is less than or equal to about 25 mm, 20 mm, 15 mm, 10 mm, 5 mm, as well as those in which the center of mass and the vertical rotation axis coincide (the center of mass is maintained along the vertical rotation axis).

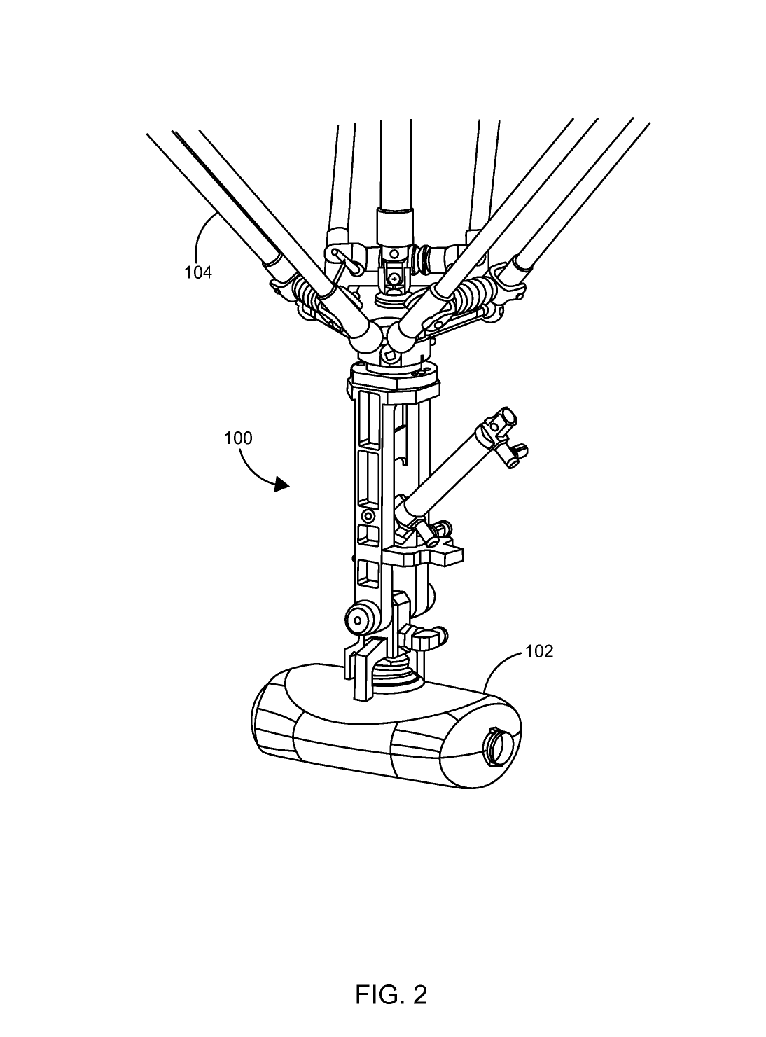

Now referring to the figures, wherein like numbers represent like elements, a gripper assembly 100 is shown in FIG. 2 gripping an exemplary article 102, although multiple article geometries are amenable to successful practice of the invention. Gripper assembly 100 is mounted on the platform of a robotic means such as robot 104 that effects translation of gripper assembly 100 through a three-dimensional space and rotation of the gripper assembly around a vertical rotation axis. Robot 104 is selected from a variety of commercially available robots and actuating arms, including but not limited to parallel kinematics robots, Spider and Delta robots, six-axis robots, SCARA robots and independently actuatable automatic arms. As illustrated, robot 104 employs independent and non-joined control arms extending from a base element and attached to a movable element to position and orient the movable element in three-dimensional space. Gripper assembly 100 is rotatably attached to the robot's movable element around the vertical rotation axis such that the gripper assembly and the movable element have a common rotational axis. The configuration of robot 104 is well known in industrial processing. The selection of robotic means is not limited to such configuration, and alternative robotic configurations are amenable for use with the gripper.

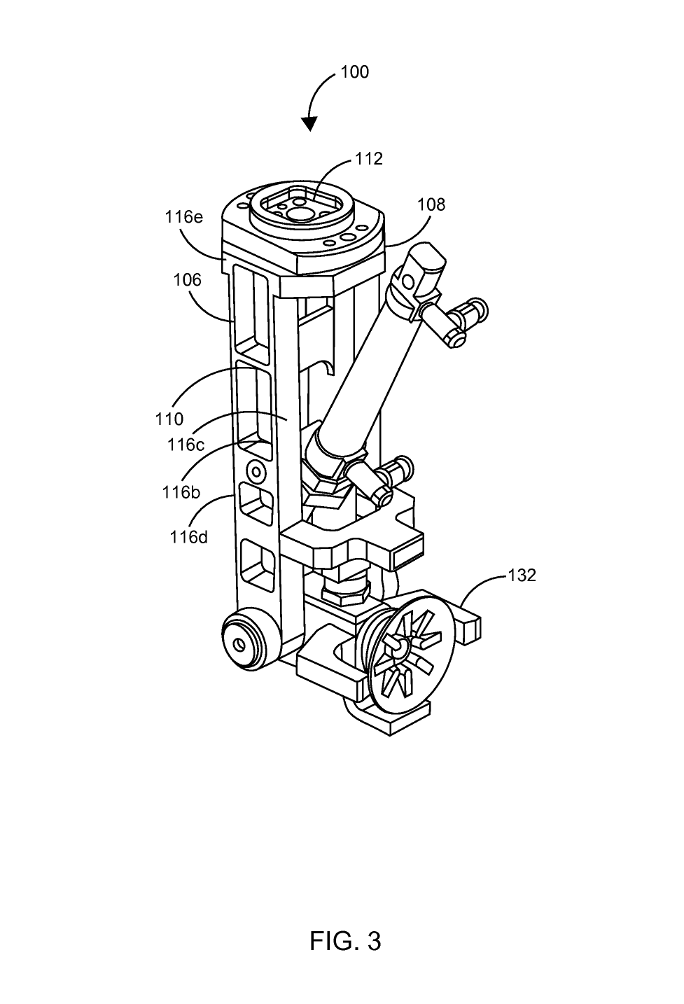

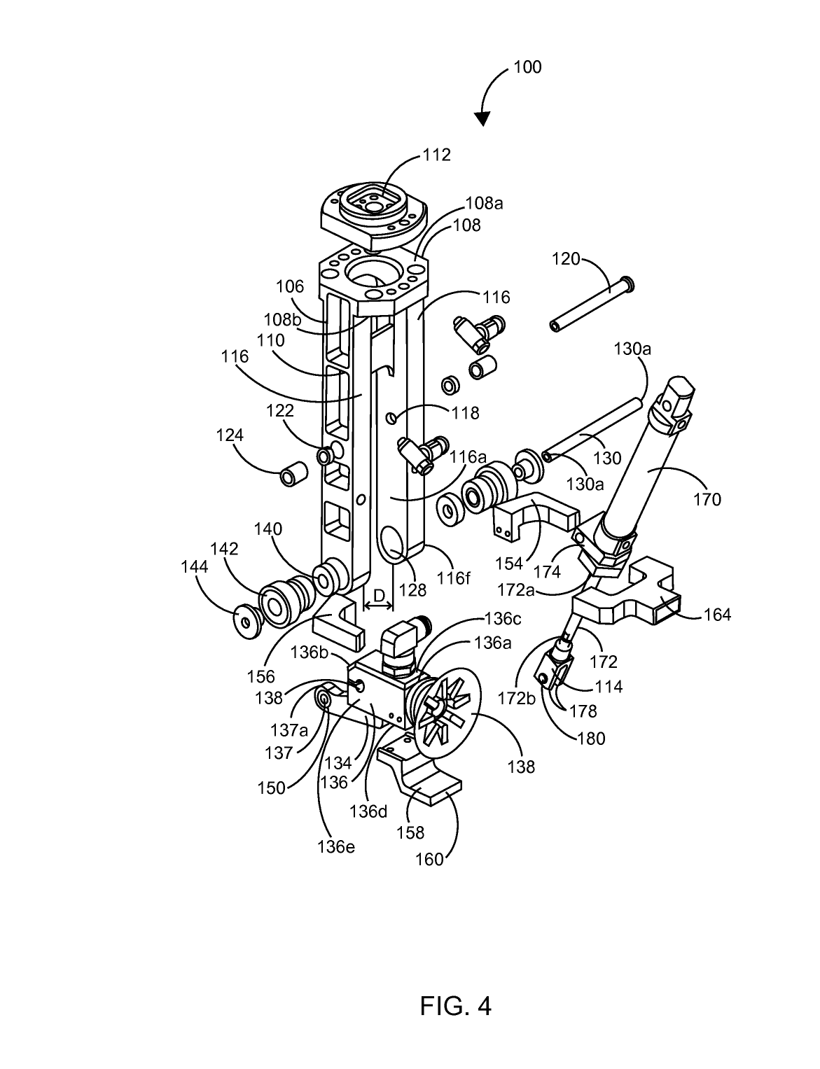

Referring further to FIGS. 3 and 4, gripper assembly 100 is illustrated in more detail. Gripper assembly 100 includes an elongate arm 106 having a platform 108 from which at least one elongate member 110 normally depends. Platform 108 has a planar upper surface 108a and an opposed planar lower surface 108b defining a predetermined thickness therebetween. Upper surface 108a of platform 108 supports an interchangeable adapter 112 thereby, which adapter may be in threaded engagement (or detachably affixed via equivalent engagement means) with at least one of platform 108 and robot 104 such that robot 104 imparts translational and rotational motion to gripper assembly 100 while the robot is in operation. The configuration of adapter 112 is one of a variety of adapter configurations that are amenable for use with the gripper assembly. Adapter 112 can assume any configuration that accommodates universal connection of gripper assembly 100 with a corresponding robotic means. The ability to switch adapter configurations with gripper assembly 100 is an advantage that permits interchangeability of gripper assembly 100 with a variety of robotic installations. Gripper assembly 100 thereby renders flexibility not only in the types of articles being picked and placed but also in the variety of tasks that can be performed in production lines across multiple industries.

At least one elongate member 110 normally depends from lower surface 108b of platform 108 such that each elongate member has a body 116 of predetermined length 1. As shown herein, a pair of elongate members 110 is shown depending generally in parallel relative to one another. It is understood, however, that arm 106 can have a single elongate member, a pair of elongate members, or three or more elongate members without departing from the scope of the invention. Each member body 116 includes an inner surface 116a separable from an adjacent member inner surface 116a by a predetermined distance D, an outer surface 116b, a front surface 116c and a rear surface 116d. At or about mid-length along each body 116 is a cylindrical shaft bore 118 defined therethrough. When there are two or more elongate members, shaft bores 118 are positioned coaxially relative to one another to accommodate insertion of a shaft 120 therethrough such that shaft 120 traverses distance D. One or both of a distance ring 122 and a bushing 124 are selectively disposed adjacent each outer surface 116b of each body 116 such that shaft 120 passes therethrough, whereby distance ring 122 can accommodate cylinder shafts of varying lengths while bushing 124 reduces vibrations imparted to elongate arm 106 during operation of gripper assembly 100.

Each member body 116 further includes a platform extent 116e adjacent lower surface 108b of platform 108 and an opposed cantilever extent 116f having a cylindrical bearing bore 128 defined therethrough. Bearing bores 128 are positioned coaxially relative to one another to accommodate insertion of a bearing shaft 130 therethrough such that bearing shaft 130 traverses distance D. Bearing shaft 130 supports a gripping mechanism such as a suction cup assembly 132 in rotatable motion relative to elongate arm 106. Suction cup assembly 132 includes a holder 134 having a suction cup base 136 with a support surface 136a, an engagement surface 136b, a top surface 136c having an optional male stud screw coupling depending normally therefrom, a bottom surface 136d and a pair of side surfaces 136e. Support surface 136a carries a suction head 138 thereat so as to retain the suction head in a generally planar orientation for ready engagement of an article container thereby. Engagement of suction head 138 with support surface 136a may be effected by frictional engagement, threaded engagement, epoxy or any other engagement means as is known in the art. Support surface 136a opposes engagement surface 136b at which base 136 engages bearing shaft 130 via insertion of bearing shaft 130 through a support bore 138 provided through base 136 near the engagement surface. One or both of a distance disk 140 and a bearing 142 are selectively disposed adjacent each outer surface 116b of each body 116 such that bearing shaft 130 passes therethrough, whereby distance disk 140 can accommodate cylinder shafts of varying lengths while bearing 142 provides a low friction bearing surface and further inhibits vibrations imparted to elongate arm 106 during operation of gripper assembly 100. An optional end cap 144 may be disposed at each terminal extent 130a of bearing shaft 130 to facilitate alignment of bearing shaft 130, distance disks 140 and bearing 142 during operation of gripper assembly 100.

Along bottom surface 136d of base 136 is a cantilevered pivoting arm 137 depending outwardly therefrom. Pivoting arm 137 is positioned adjacent engagement surface 136b and terminates in a pivoting extent 137a having a pivoting bore 150 defined thereat. A plain bearing (not shown) may be disposed in pivoting bore 150 to provide a low-friction bearing surface thereby. Pivoting arm 137 may be integral with base 136 or otherwise detachably affixed thereto such that rotation of suction cup assembly 132 imparts generally simultaneous movement to both base 136 and pivoting arm 137.

A frame comprising supports 156 and clutch 158 is selectively positioned relative to suction head 138 such that the suction head is disposed between supports 156. Clutch 158 includes retention means such as a flange (not shown) for fastening of the clutch to base 136 along bottom surface 136d of base 136 and a seat 160 that accommodates disposition of suction head 138 thereadjacent. An adapter 164 may also be provided along a length of member bodies 116 adjacent front surfaces 116c thereof intermediate suction cup assembly 132 and an actuating element (further described hereinbelow).

Gripper assembly 100 further includes an actuator means to establish pivotable communication with pivoting arm 137 and thereby impart rotational motion to suction cup assembly 132. As further shown in FIGS. 3 and 4, an actuator means is provided in the configuration of a pneumatic cylinder 170 (which may be selected from one of several commercially available pneumatic actuators) is provided that can be disposed relative to inner surfaces 116a of member bodies 116 so as to be pivotably movable relative to elongate arm 106. Although pneumatic cylinder 170 is depicted as an exemplary actuator, it is understood that one or more alternative actuators can be substituted therefore, including electronic and mechanical actuation means as are known in the art.

A linkage element 172 operably coupled to pneumatic cylinder 170 has a coupled extent 172a proximate a yoke 174 and a free extent 172b with an engagement means defined thereat. An exemplary engagement means is shown as a fork head 176 having a pair of tines 178 wherein each tine 178 has a fastening bore 180 defined therethrough. Fastening bores 180 are in coaxial alignment with one another such that fastening bores 180 are in registry with pivoting bore 150 when pivoting arm 137 is disposed between tines 178. Fastening bores 180 accommodate engagement of at least one fastening member with tines 178, such as by frictional engagement, complementary threaded engagement between a threaded fastening member and corresponding threads defined in fastening bores 180 or any other means for engagement as is known in the art.

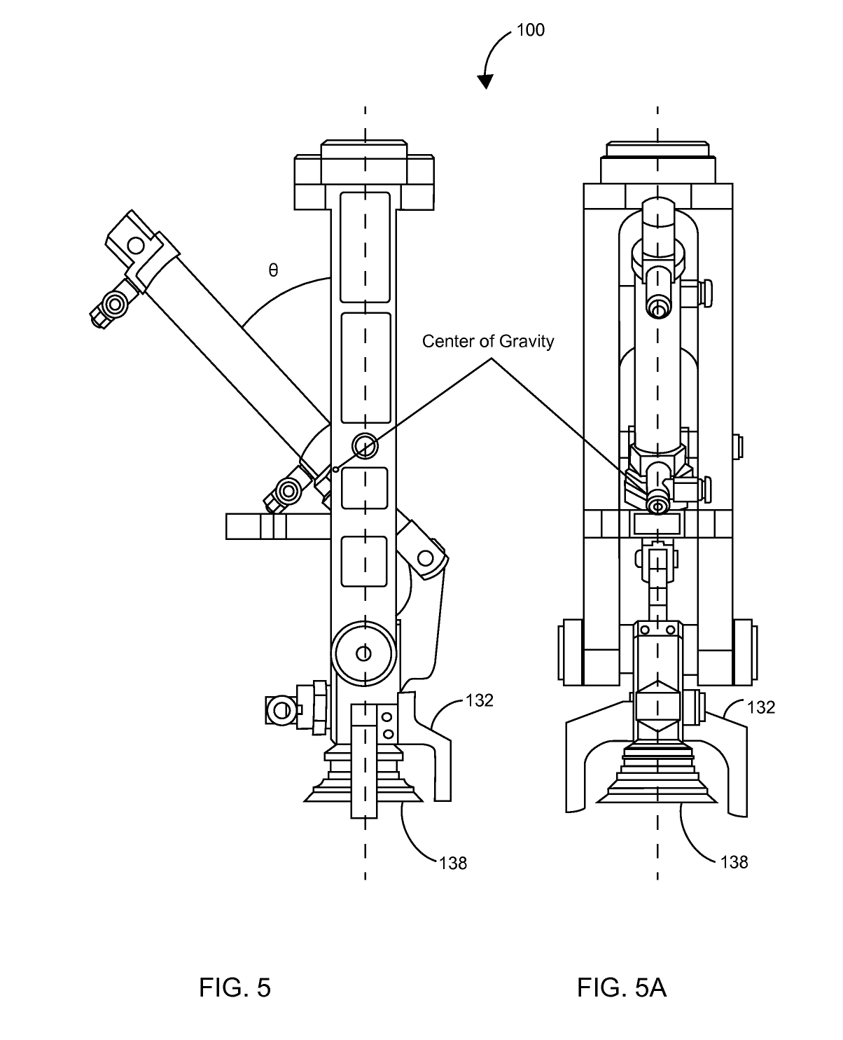

As readily seen in the figures, suction cup assembly 132 is mounted on pivoting arm 137 to effect rotation about a horizontal axis X (seen in FIG. 5) upon actuation of pneumatic cylinder 170. The position of pneumatic cylinder 170 ensures that all masses are concentrated in correspondence of the axis of rotation of gripper assembly 100 (that is, the center of rotation and the center of mass of gripper assembly 100 are disposed along coincident axes and maintained therealong during actuation of pneumatic cylinder 170 and resultant rotation of suction cup assembly 132). Such configuration substantially reduces vibratory disturbances realized along elongate arm 106 and also avoids any collisions between pneumatic cylinder 170 and the picked article.

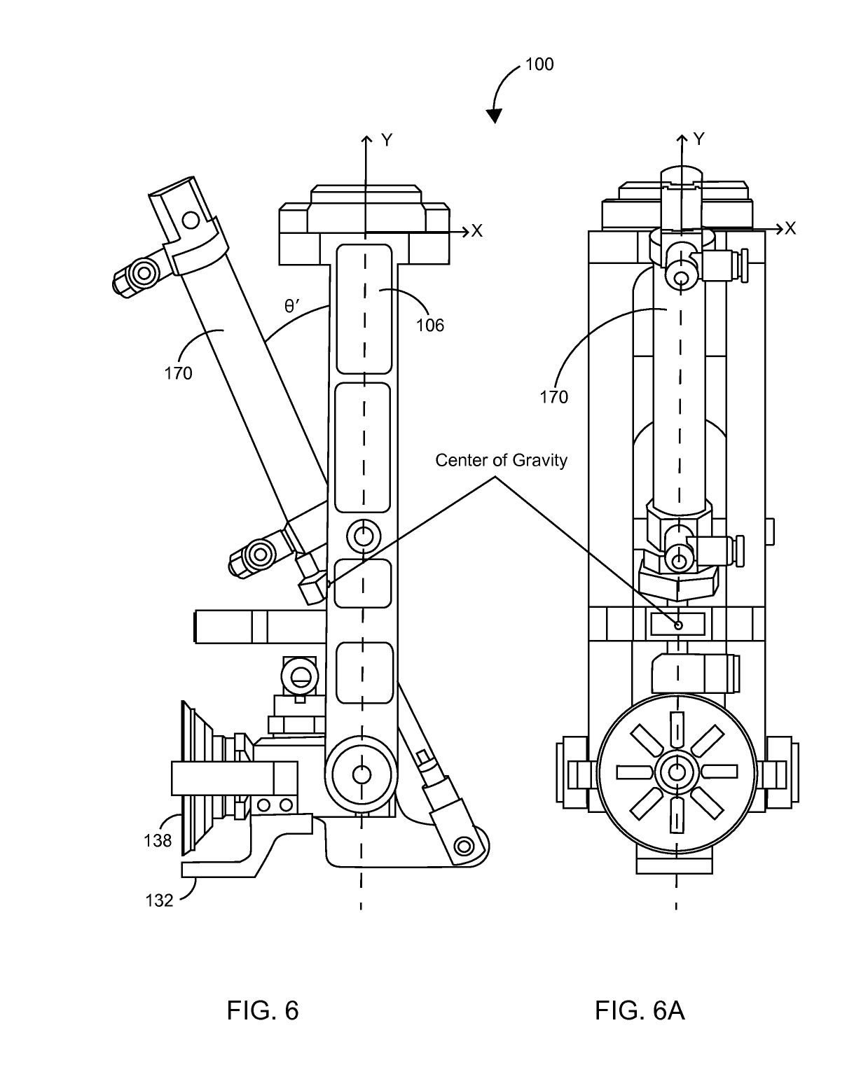

Gripper assembly 100 is further shown during operation between an initial article picking position (described with reference to FIGS. 5 and 5A) and a successive article placement position (described with reference to FIGS. 6 and 6A). In the initial article picking position shown in FIGS. 5 and 5A, gripper assembly 100 is shown as having a center of gravity disposed near or along a vertical rotation axis Y. Pneumatic cylinder 170 is disposed at an initial angle θ relative to the rotation axis, at which angle suction head assembly 132 disposes suction head 138 along a horizontal plane. In this configuration, suction head 138 is positioned in an initial article picking position for ready engagement with one or more articles in succession as directed by robot 104.

Upon actuation of pneumatic cylinder 170 to the successive article rotation position as shown in FIGS. 6 and 6A, pneumatic cylinder 172 pivots toward front surfaces 116c of member bodies 116 so as to approach a subsequent angle θ′. As a consequence of angular displacement of pneumatic cylinder 170, linkage element 172 coupled thereto imparts rotational motion to pivoting arm 137 such that suction head assembly 132 rotates generally through a 90° path to an article placement position (e.g., suction head 138 is disposed in a generally vertical plane or in any plane defined along the angular path between the article picking position defined at angle 0 and the article placement position defined at angle θ′). Throughout rotational movement of suction cup assembly 132 along bearing shaft 130, suction head 138 retains engagement with the picked article so as to orient the picked article to an article placement position via rotation of the picked article around a horizontal axis. In this successive position, the center of mass of gripper assembly 100 is substantially aligned with the gripper assembly's vertical rotation axis even though the horizontal axis positioning of the centers of mass and rotation changes between the initial article picking position and the successive article rotation position. Vibratory disturbance along elongate arm 106 is thereby ameliorated throughout operation of gripper assembly 100.

### EXAMPLE 1

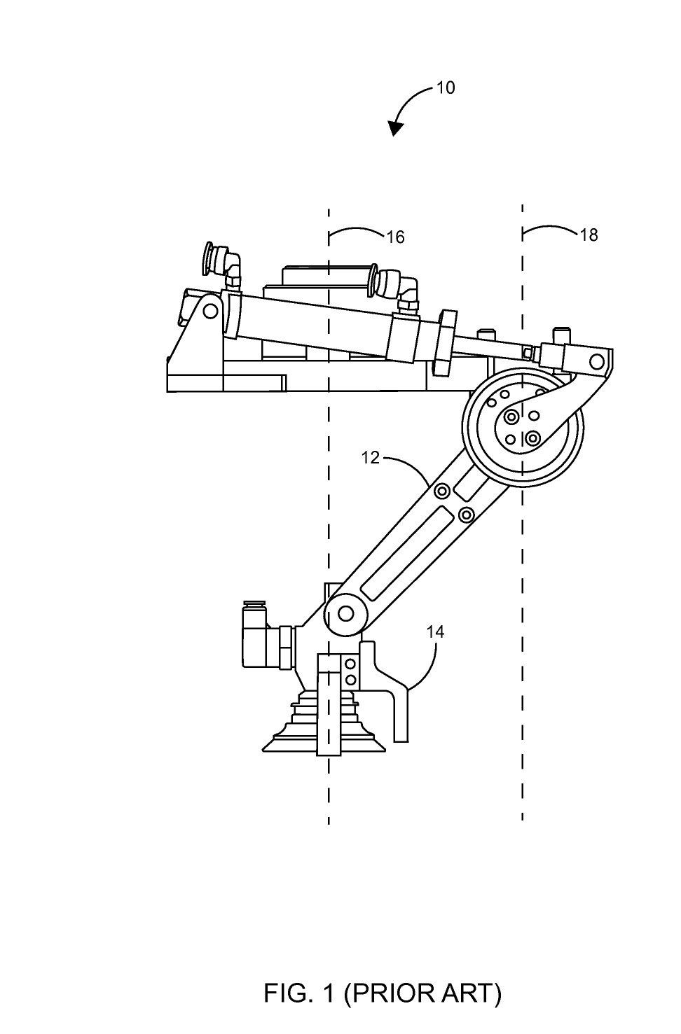

A first gripper assembly is constructed according to the industry standard described hereinabove with respect to FIG. 1. The gripper picks up a bottle having a mass of 0.15 kg and width of 130 mm The overall mass of the gripper is 1.20 kg. The axis of rotation is offset from the axis along which the gripper's center of mass is disposed by a distance of 90 mm

Inertia/Force on Bottle:
r=width of bottle/2=65 mm
J_{Bottle}= 1/2 mr²=316.88 kg/mm²

Inertia on robot for rotation movement:
r=90 mm
J_{Gripper}=m*r²=9720 kg/mm²
J_{Gripper}+J_{Bottle}=10036.88 kg/mm²

Thus, high flipping inertia is realized by the bottle.

### EXAMPLE 2

A second gripper assembly is constructed as shown and described with reference to FIGS. 2 to 4 herein. The gripper is in an initial article picking position as shown in FIGS. 5 and 5A when the gripper picks up a bottle having a mass of 0.15 kg.

Center of gravity:
X=−2.6 mm
Y=−106.4 mm
Z=−2.9 mm

Inertia of rotation around Y-axis:
J_{Y}=883.9 kg/mm²

### EXAMPLE 3

A third gripper assembly is constructed according as shown and described with reference to FIGS. 2 to 4 herein. The gripper is in a successive article rotation position as shown in FIGS. 6 and 6A when the gripper engages a picked bottle having a mass of 0.15 kg.

Center of gravity:
X=−3.9 mm
Y =−106.2 mm
Z=−29 mm

Inertia of rotation around Y-axis:
Jy=783.4 kg/mm²

The disclosed gripper assembly is capable of performing all of the activities of industry standard gripper assemblies with optimal MTBF. That is, the gripper assembly achieves article picking via a vacuum means, flipping of the picked article via rotation around a horizontal axis, orientation of the article via rotation around a vertical axis, movement of the article to a final destination for placement into a carrier or upon a conveyance device and release of the picked article in a stable, conveyable position for further treatment. The gripper design shown herein minimizes material utilization and thereby makes the configuration amenable to lightweight but rigid materials such as aluminum (although other fabrication materials are contemplated, including but not limited to the group of materials comprising metals, reinforced plastics and composites). Selection of such materials minimizes the weight of the gripper assembly without compromising the effectiveness of gripper activity in an around-the-clock operation. Engagement among all critical components is effected so as to ensure high stiffness of the gripper assembly throughout operation.

The disclosed gripper assembly realizes minimum rotational inertia, minimum translational inertia, minimum flipping inertia in a fast-flipping mechanism that maintains high speed and enhanced reliability. With these characteristics, the gripper assembly exhibits enhanced flexibility in the accommodation of articles of numerous sizes, shapes, textures, contours and material compositions and which are fabricated according to a variety of production techniques (including but not limited to injection molding, extrusion, blow-molding and complementary and other known production techniques as are known in the art for producing articles of manufacture). The attenuation of maintenance time attributable to changeover in gripper assembly configurations contributes to the successful operation of the disclosed gripper assembly and the reduction in the number of present invention gripper assemblies that are required on any one assembly line. With significantly increased MTBF, regular maintenance is thereby reduced and the number of robots required in any given installation is also reduced as the current gripper design realizes higher pick and place rates relative to the industry standard configuration.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A gripper assembly for use with a mechanical device for picking an article from a random orientation and placing said article into an article placement position, comprising:
an elongate arm having a platform with a planar upper surface and an opposed planar lower surface defining a predetermined thickness therebetween; at least one elongate member depending normally from said lower surface of said platform such that each member has a body of predetermined length; each body further including a platform extent adjacent said lower surface of said platform and an opposed cantilever extent having a bearing bore defined therethrough to accommodate insertion of a bearing shaft;
a gripping mechanism rotatably supported by said bearing shaft relative to said arm wherein said gripping mechanism includes a holder having a support bore to accommodate insertion of said bearing shaft therethrough, and a pivoting arm depending outwardly from a bottom surface of said holder and terminating in a pivoting extent having a pivoting bore defined thereat;
an actuator means in operable communication with said pivoting arm so as to impart pivotable movement to said pivoting arm and rotational motion to said gripping mechanism about a horizontal axis upon actuation of said actuator means, said actuator means disposed relative to said body so as to be pivotably movable relative to said arm; and
a linkage member having a coupled extent operably coupled with said actuator means and a free extent with an engagement means defined thereat for operable engagement with said gripping mechanism;
wherein said gripper assembly has a center of mass substantially aligned with a vertical axis of rotation of said gripper assembly during actuation of said actuator means.

2. The gripper assembly of claim 1, wherein said elongate arm includes at least a pair of elongate members depending normally from said lower surface of said platform, with each said body having an inner surface separable from any adjacent inner surface by a predetermined distance and each said bearing bore being positioned coaxially relative to each other said bearing bore to accommodate insertion of said bearing shaft therethrough.

3. The gripper assembly of claim 2, wherein said actuator means is disposed relative to each said body of each said elongate member so as to be pivotably movable relative to said elongate arm.

4. The gripper assembly of claim 1, wherein said actuator means comprises a pneumatic cylinder.

5. The gripper assembly of claim 1, wherein said gripping mechanism comprises suction cup assembly including a base with a support surface for retention of a suction head in a generally planar orientation.

6. The gripper assembly of claim 1, wherein said gripper assembly is rotatably mounted with a robotic means that effects translation of said gripper assembly on a horizontal plane and rotation of said gripper assembly around said vertical rotation axis.

7. The gripper assembly of claim 6, wherein said platform of said elongate arm supports an interchangeable adapter in engagement with said robotic means.

8. The gripper assembly of claim 1, wherein said engagement means comprises a pair of tines with each tine having a fastening bore defined therethrough, such that each said fastening bore is in coaxial alignment with each other said fastening bore, and such that fastening bores are in registry with said pivoting bore when said pivoting arm is disposed between said tines.

9. The gripper assembly of claim 8 wherein said fastening bores accommodate engagement of at least one fastening member with said tines and said pivoting bore.

10. The gripper assembly of claim 9, wherein said engagement of said at least one fastening member with said tines is effected by at least one of frictional engagement and complementary threaded engagement between a threaded fastening member and corresponding threads defined in said fastening bores.

11. The gripper assembly of claim 1, wherein each said body includes a shaft bore defined therethrough such that said shaft bores are positioned coaxially relative to one another to accommodate insertion of an alignment shaft.

12. The gripper assembly of claim 1, wherein said pivoting arm is integral with said holder.

13. A gripper assembly for use with a mechanical device for picking an article from a plurality of articles randomly distributed along a conveyance apparatus, comprising:
an elongate arm in engagement with robotic means that effects translation of said gripper assembly on a horizontal plane and rotation of said gripper assembly around a vertical rotation axis; said elongate arm having a platform with at least one elongate member depending normally from a lower surface thereof; each said elongate member having a body of predetermined length with each body having an inner surface separable from any adjacent inner surface by a predetermined distance; each body further including a platform extent adjacent said lower surface of said platform and an opposed cantilever extent having a cylindrical bearing bore defined therethrough such that each said bearing bore is positioned coaxially relative to any other said bearing bore to accommodate insertion of a bearing shaft;
a gripping mechanism rotatably supported by said bearing shaft relative to said elongate arm, wherein said gripping mechanism includes a holder having a bore to accommodate insertion of said bearing shaft therethrough; said holder having a pivoting arm depending outwardly from a bottom surface thereof terminating in a pivoting extent having a pivoting bore defined thereat;
an actuator means having a linkage member with a coupling extent in operable communication with said actuator means and a free extent with a fork head defined thereat, wherein said fork head includes a pair of tines wherein each tine has a fastening bore defined therethrough such that said fastening bores are in coaxial alignment with one another, and wherein said fastening bores are in registry with said pivoting bore when said pivoting arm is disposed between said tines to establish operable communication between said linkage member and said pivoting arm; said actuator means disposed relative to each said body of each said elongate member so as to be pivotably movable relative to said elongate arm; whereupon actuation of said actuator means, said pivoting arm imparts rotational motion to said gripping mechanism about a horizontal axis;
wherein said gripper assembly has a center of mass substantially aligned with said vertical rotation axis between an initial article picking orientation, in which said gripping mechanism engages an article in a random orientation, and a successive article rotation orientation, in which said gripping mechanism rotates a picked article around a horizontal axis for placement in an article placement position.

14. The gripper assembly of claim 13, wherein said actuator means comprises a pneumatic cylinder.

15. The gripper assembly of claim 13, wherein said gripping mechanism comprises a suction cup assembly including a base with a support surface for retention of a suction head in a generally planar orientation.

16. The gripper assembly of claim 13, wherein said platform of said elongate arm supports an adapter in engagement with said robotic means.

17. The gripping assembly of claim 13, wherein said fastening bores accommodate engagement of at least one fastening member with said tines.

18. The gripper assembly of claim 1, wherein each said body includes a cylindrical shaft bore defined therethrough such that said shaft bores are positioned coaxially relative to one another to accommodate insertion of an alignment shaft.

19. The gripper assembly of claim 1, wherein said pivoting arm may be integral with said holder such that rotation of said gripping assembly imparts generally simultaneous movement to said pivoting arm.
